(19) United States
(12) Patent Application Publication
(10) Pub. No.: US 2005/0092151 A1
(43) Pub. Date: May 5, 2005

(54) Stripper-plate alignment system and die set

(76) Inventor: Thomas H. Rooney JR., Oaklyn, NJ (US)

Correspondence Address: MARILYN F. WRIGLEY;ROUTE 1 BOX 228-A, MONTONE, AL, 35984, US

(21) Appl. No.: 11/001,933

(22) Filed: Dec. 1, 2004

Related U.S. Application Data
(62) Division of application No. 10/624,236, filed on Jul. 22, 2003.
(60) Provisional application No. 60/398,855, filed on Jul. 26, 2002.

(51) Int. Cl. B26D 7/06

(52) U.S. Cl. 83/140; 83/383

(57) ABSTRACT

A stripper-plate for a progressive die sets is provided including open-ended tubular guide bushings that project outwardly from at least one side. A first anti-friction bearing assembly is positioned within each of the guide bushings, and a second anti-friction bearing assembly is positioned on an outer surface of each of the guide bushings. A die set is also provided including an upper die shoe having a plurality of guide posts arranged in a pattern and projecting outwardly from a surface. A lower die shoe is arranged in confronting relation to the surface of the upper die shoe, and includes a first plurality of open ended tubular guide bushings positioned so as to each receive a corresponding one of the guide posts. A first anti-friction bearing assembly is positioned within each of the guide bushings. A stripper-plate is positioned between the upper die shoe and the lower die shoes, and includes a second plurality of open-ended tubular guide bushings each having an outer surface and an inner surface. The second guide bushings project outwardly toward the lower die shoe in a pattern that corresponds to the pattern of guide posts. Each of the first anti-friction bearing assemblies slidingly engages an outer surface of a corresponding one of the second guide bushing. Each of the second guide bushings includes a second anti-friction bearing assembly that is positioned on an inner surface so as to engage a corresponding one of the guide posts.

### CROSS-REFERENCE TO RELATED APPLICATIONS

This application claims the benefit of U.S. Provisional Patent Application No. 60/398,855, filed Jul. 26, 2002.

### FIELD OF THE INVENTION

The present invention generally relates to metal forming equipment and, more particularly, to progressive metal stamping dies.

### BACKGROUND OF THE INVENTION

Progressive metal stamping in which a metal strip or the like is guided along a predetermined path through a die set in cadence with the operation of a reciprocating press is well known. Prior art metal stamping die sets typically consist of confronting upper and lower die shoes, where one or the other of the die shoes includes two or more solid metal guide posts (usually four) affixed to it, and the other of the die shoes includes a corresponding number of bushings affixed to it. The bushings receive the guide posts, and thereby serve to guide the shoes as they are brought together during reciprocating press operation for the forming or punching of a metal strip. A plurality of tools are positioned on the inner punching of a metal strip. A plurality of tools are positioned on the inner confronting surfaces of the upper and lower die shoes that are circumscribed by the posts and bushings. These tools are shaped and sized to enable piercing, punching, drawing, or other operations to be performed upon the metal strip as it progresses through the die set.

Upon each reciprocating movement or “stroke” of the press, the metal strip is lifted and then advanced by one step through the die set. The tools that are located on the upper die shoe, above the metal strip, thus move toward and away from the surface of the metal strip during each full cycle of the press. These tools, often simply referred to as “punches,” are guided through a stripper-plate which is located just above the metal strip. The stripper-plate often has a plurality of guide openings to guide the punches toward the metal strip, and to retain the metal strip in position during the punching, piercing, or drawing operation, while permitting movement of the metal strip as it is progressively fed through the die between punching strokes. The stripper-plate is pressed by releasable spring pressure against the metal strip during each downward stroke of the press. The punches pass through the guide openings in the stripper-plate during the downward stroke of the press and toward the metal strip. The punches engage or penetrate the metal strip and then are retracted with the upward stroke of the press. During the upward stroke of the press, as the punches are pulled away from the metal strip, the metal strip is pulled or “stripped” off the punches by the stripper-plate. At the same time, the spring pressure is released from the stripper-plate, which then also moves away from the metal strip, thereby releasing the metal strip so that it may be advanced an incremental step through the die set prior to the next downward stroke.

Because of the complex timed movement of the foregoing elements, it is essential that accuracy be maintained in guiding the upper and lower die shoes together, so that the mating parts of the die set, i.e., tools and recesses, cooperate as intended, otherwise damage and destruction of the tools mounted on the die set, and possibly also the press itself, may result. Thus, the solid guide post and bushing system along with the stripper-plate are essential to optimum progressive die and press operations.

In order to make this metal forming system more rigid and thereby afford greater accuracy, single ball bearing cages located between the outer surface of the guide posts and guide bushings have been used in many prior art progressive dies. As alignment of the punching components has become more critical over time, the stripper-plate has become the mechanism to guide the male punching components into the female components. To accomplish this critical task, a second system of guide posts and bushings has often been added to the first set of guide posts and bushings. The second system of guide posts and bushings are located on the interior confronting surfaces of the die shoes. As a function of available space within the die set and press, this second system of guideposts necessarily has to be smaller than the first guide posts and bushings that guide the upper and lower die shoes together. As a consequence, prior art die sets have increased accuracy through greater rigidity in the system by trading a smaller bearing surface to guide the stripper-plate and therethrough guide the punches, and a greater bearing surface to guide the upper die shoe. Unfortunately, the upper die shoe often does not require the same accuracy as the stripper-plate. The second system of guide posts and bushings also limits the effective work surface available in the die set for the varied operations now required from high speed metal stamping.

One way to increase both the bearing surface and guidance of the stripper-plate is to use very large (diameter) guide posts and guide them directly into bushings in the lower shoe. This technique has been found, however, to add considerable weight to the stripper-plate, requiring larger spring constant springs to provide additional releasable spring pressure in an already crowded workspace. This technique also often inhibits press running speeds.

As a consequence, there has been a long felt need for a metal stamping die set that has a maximum workspace available between the upper and lower die shoes, while at the same time, provides for reliable, high speed press operation and greater die set and stripper-plate accuracy.

### SUMMARY OF THE INVENTION

The present invention provides a metal stamping system including a press having a reciprocating ram. A bulbous protrusion projects outwardly from an end of the ram. An upper die shoe is provided including (i) a recess formed in a top surface, the recess being complementary to the bulbous protrusion, and (ii) a plurality of guide posts arranged in a pattern and projecting outwardly from a bottom surface. During operation of the system, the bulbous protrusion is freely received within the complementary recess, i.e., the bulbous protrusion is not fastened to the upper shoe. A lower die shoe is positioned in confronting relation to the surface and includes a first plurality of open ended tubular guide bushings each having a first anti-friction bearing assembly positioned within a central passageway, and each located so as to receive a corresponding one of the guide posts. A stripper-plate is positioned between the upper die shoe and the lower die shoe. The stripper-plate includes a second plurality of open-ended tubular guide bushings each having an outer surface and an inner surface and each projecting outwardly toward the lower die shoe in a pattern corresponding to the pattern of guide posts. In this way, each of the first anti-friction bearing assemblies slidingly engages an outer surface of a corresponding one of the second open ended guide bushing. Each of the second plurality of open-ended guide bushings includes a second anti-friction bearing assembly that is positioned on the inner surface so as to engage a corresponding one of the guide posts. Spring means are provided for separating the upper shoe from the lower shoe after each downward stroke of the ram.

In an alternative embodiment of the invention, a die set is provided of the type that is to be reciprocatingly driven in a stamping press. The die set of the invention includes an upper die shoe including (i) a recess formed in a top surface, the recess being complementary to a bulbous protrusion located on a ram portion of the press, and (ii) a plurality of guide posts arranged in a pattern and projecting outwardly from a bottom surface. The bulbous protrusion is freely received within the complementary recess. A lower die shoe is positioned in confronting relation to the surface, and includes a first plurality of open ended tubular guide bushings each having a first anti-friction bearing assembly positioned within a central passageway, and each located so as to receive a corresponding one of the guide posts. A stripper-plate is positioned between the upper die shoe and the lower die shoe. The stripper-plate includes a second plurality of open-ended tubular guide bushings, each having an outer surface and an inner surface and each projecting outwardly toward the lower die shoe in a pattern corresponding to the pattern of guide posts. In this way, each of the first anti-friction bearing assemblies slidingly engages an outer surface of a corresponding one of the second open ended guide bushing. Each of the second plurality of open-ended guide bushings includes a second anti-friction bearing assembly positioned on the inner surface so as to engage a corresponding one of the guide posts.

### BRIEF DESCRIPTION OF THE DRAWINGS

These and other features and advantages of the present invention will be more fully disclosed in, or rendered obvious by, the following detailed description of the preferred embodiments of the invention, which are to be considered together with the accompanying drawings, wherein like numbers refer to like parts and further wherein:

FIG. 1 is a partially broken-away, front elevational view of a high speed metal stamping press including a die set and stripper alignment system formed in accordance with the present invention;

FIG. 2 is a top elevational view of an upper die shoe;

FIG. 3 is a side elevational view of the upper die shoe shown in FIG. 2;

FIG. 4 is a top elevational view of a lower die shoe;

FIG. 5 is a side view of the lower die shoe shown in FIG. 4;

FIG. 6 is a top view of a stripper-plate formed in accordance with the present invention;

FIG. 7 is a side view of the stripper-plate shown in FIG. 6;

FIG. 8 is a partially broken-away, cross-sectional view of assembled upper and lower die shoes, a stripper-plate, and including a stripper-plate alignment system formed in accordance with the present invention;

FIG. 9 is a partially broken-away, partially phantom, view of a portion of the stamping press shown in FIG. 1, having a side-by-side pair of die sets, each including a stripper-plate alignment system formed in accordance with the invention, mounted to an intermediate locator plate positioned on the bolster of the press;

FIG. 10 is a side elevational view, partially in phantom, of a pair of upper die shoes arranged in accordance with an alternative embodiment of the invention;

FIG. 11 is a side elevational view, partially in phantom, of a pair of stripper-plates arranged in accordance with an alternative embodiment of the invention; and

FIG. 12 is a side elevational view, partially in phantom, of a single lower die shoe arranged in accordance with an alternative embodiment of the invention.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

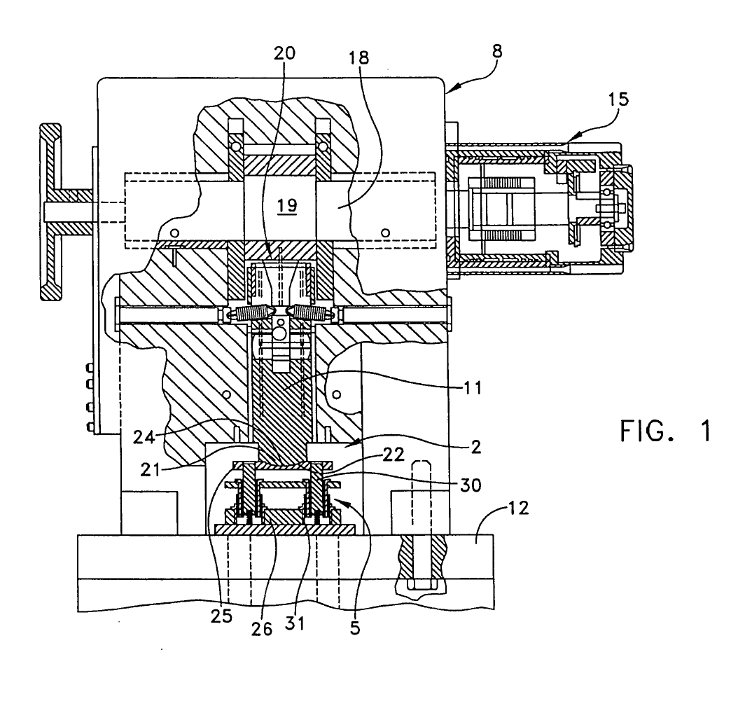

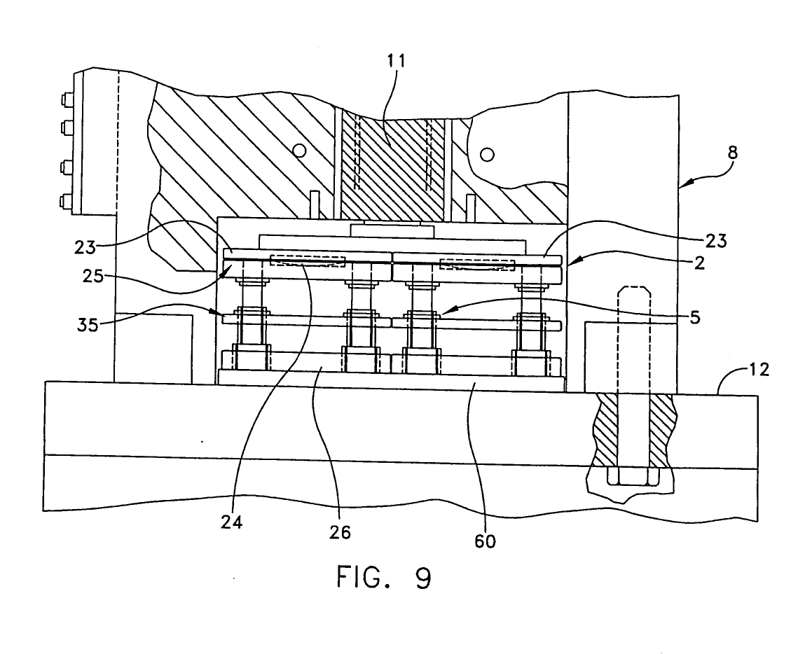

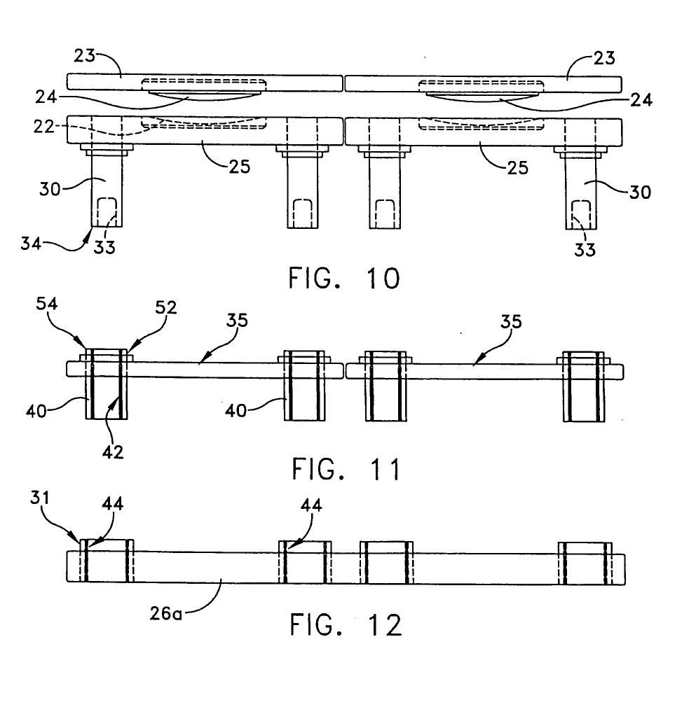

Referring to FIG. 1, a die set 2 comprising a stripper-plate alignment system 5 formed in accordance with the present invention is often mounted within a high speed stamping and forming press 8 of the type well known in the art. For example, a typical high speed stamping and forming press 8 includes a ram 11 that moves toward and away from a bolster plate 12 at a rate of between approximately 1,000-3000 strokes per minute, or more. The length of the stroke is often about 0.25 inches. An electric motor 15 is coupled to a drive shaft 18 having an eccentric 19 which drives ram 11 by means of a crank 20. Drive shaft 18 and crank 20 are journaled in hydrostatic bearings, and ram 11 is journaled in a linear hydrostatic bearing, including fluid conduits, all of which are specially designed to allow high speed stamping and forming press 8 to operate at the above-mentioned 1,000-3000 strokes per minute. In the present invention, end 21 of ram 11 includes an outwardly projecting bulbous protrusion 22, such as a chord of a sphere, on the surface of ram 11 that opposes bolster plate 12. In some arrangements, an intermediary plate 23, having an outwardly projecting bulbous protrusion 22, may be positioned between upper die shoe 25 and end 21 of ram 11 so as to distribute forces more equally, and allow for retrofitting of prior art presses in the field (FIGS. 9 and 10).

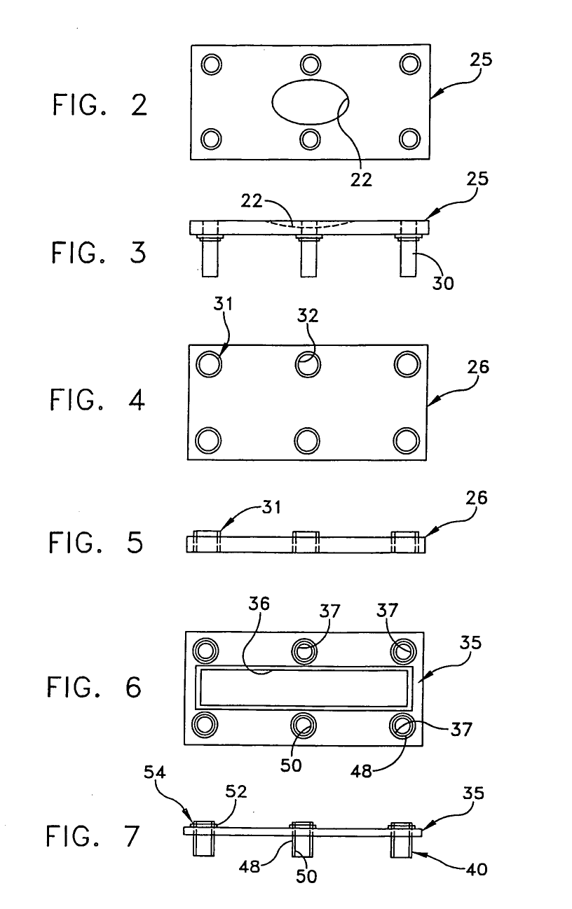

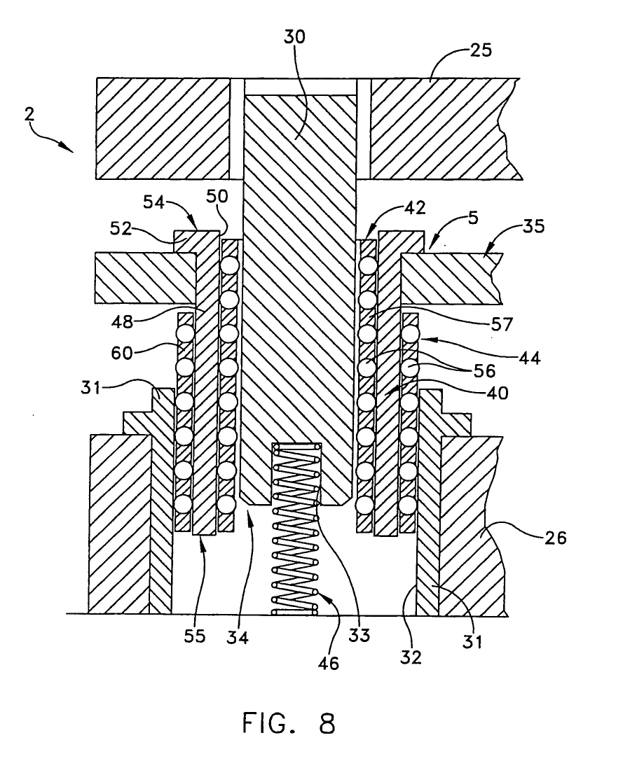

Referring to FIGS. 1-5, die set 2 comprises an upper shoe 25 attached to and carried by ram 11, and a mating lower die shoe 26 secured to bolster plate 12 in a conventional manner well known in the art. Two or more guide posts 30 project downwardly from upper die shoe 25, and are received within internal passageways 32 of correspondingly positioned guide bushings 31 mounted in lower die shoe 26. In one preferred embodiment of the present invention, six mating pairs of guide posts 30 and guide bushings 31 are arranged on upper die shoe 25 and lower die shoe 26. Each guide post 30 includes a recess 33 defined at a free end 34 (FIG. 8). Upper die shoe 25 also includes a ram coupler comprising a recess 24 defined in a top surface. Ram coupler 24 is adapted to non-fixedly engage complementarily shaped bulbous protrusion 22 on the end of ram 11. The engagement is such that ram 11 can force upper die shoe 25 downwardly toward lower die shoe 26. Some relative motion is permitted within the coupling between ram 11 and upper die shoe 25 as a result of the implementation of stripper-plate alignment system 5.

Referring to FIGS. 1, 6-7, and 8, a stripper-plate 35 is located between upper die shoe 25 and lower die shoe 26, and is maintained in position via stripper-plate alignment system 5 (FIGS. 1 and 8). Stripper-plate 35 comprises one or more central openings 36 that receive punches and the like (not shown) and peripheral through-bores 37 arranged in a pattern that corresponds to the pattern of guide posts 30 and guide bushings 31 on upper die shoe 25 and lower die shoe 26.

Referring to FIGS. 6-8, stripper-plate alignment system 5 is assembled between upper shoe 25 and lower shoe 26, and comprises a plurality of stripper guide bushings 40, a plurality of internal anti-friction bearing assemblies 42, a plurality of external anti-friction bearing assemblies 44, and a plurality of return springs 46. In a preferred embodiment of the invention, there is at least one stripper guide bushing 40, one internal and one external anti-friction bearing assemblies 42,44, and a return spring 46 associated with each pair of guide posts 30 and guide bushings 31. Of course, other arrangements of return springs are possible, as long as such structures allow for the axially upward displacement of upper die shoe 25 upon each upward portion of the stroke of ram 11. Each stripper guide bushing 40 comprises an open ended, cylindrical tube 48 having an internal passageway 50, an annular shoulder 52 that projects radially outwardly from a top end 54, and includes a bottom end 55. Internal passageway 50 of each stripper guide bushing 40 is defined by the hardened internal surface of cylindrical tube 48, and is sized to slidingly accept an internal anti-friction bearing assembly 42 and a guide post 30.

Each internal anti-friction bearing assembly 42 includes a plurality of circularly and longitudinally spaced ball bearings 56 that are each confined in a bearing cage 57. Each bearing cage 57 is preferably cylindrical, and is sized so as to longitudinally enclose and encircle a guide post 30 with appropriate space between guide post 30 and bearing cage 57 to avoid contact between them, but to allow for a prestressed loading of ball bearings 56 against the outer surface of guide post 30. The outer surface of each guide post 30 is hardened, ground, and polished to permit relative longitudinal movement between ball bearings 56, bearing cage 57, and guide post 30 with good control so as to prevent relative rotational movement between them. The foregoing assembly is very often lubricated with an appropriately selected oil or other lubricant of the type that is well known in the art.

Each external anti-friction bearing assembly 44 also includes a plurality of circularly and longitudinally spaced ball bearings 56 that are each confined in a bearing cage 60. Bearing cage 60 is also cylindrical, and each is sized so as to (i) longitudinally enclose and encircle a stripper guide bushing 40, and (ii) be received within internal passageway 32 of lower die shoe guide bushing 31 with appropriate space between lower die shoe guide bushing 31, stripper guide bushing 40 and bearing cage 60 to avoid contact between them. The outer and inner surfaces of each stripper guide bushing 40 are often hardened, ground, and polished to permit relative, self-aligning longitudinal movement between ball bearings 56 of both internal anti-friction bearing assembly 42 and external anti-friction bearing assembly 44 with good control so as to prevent relative rotational movement between them. The foregoing assembly is also very often lubricated with an appropriately selected oil or other lubricant well known in the art.

The present invention is assembled to die set 2 in the following manner. Stripper-plate 35 is first arranged with a stripper guide bushing 40 press-fit within each peripheral through-bore 37. In this arrangement, each annular shoulder 52 engages an upper surface of stripper-plate 35 adjacent to the entrance to a through-bore 37 so as to seat stripper guide bushing 40 within through-bore 37. Internal anti-friction bearing assemblies 42 are then preloadingly press-fit within internal passageways 50 of each stripper guide bushing 40. The “prestressing” or “preloading” of internal anti-friction bearing assemblies, i.e., preloading bearings 56 against the internal surface of stripper guide bushing 40, provides a mechanical coupling of these structures, which in turn, allows for a mechanical and structural coupling of guide posts 30 and lower die shoe guide bushings 31 to stripper-plate 35. Thus, the internal and external bearing assemblies 42,44, provide both anti-frictional movement between guide posts 30, stripper guide bushing 35, and lower die shoe guide bushings 31, and a structural coupling of these structures which effects a highly accurate guidance of these moving parts.

With stripper guide bushings 40 and internal anti-friction bearing assemblies 42 assembled to stripper-plate 35, it is then positioned between upper die shoe 25 and lower die shoe 26 such that guide posts 30, stripper guide bushings 40, and lower die shoe guide bushings 31 are arranged in confronting coaxial relation to one another. Coil springs 46 are positioned within recesses 33 at bottom free end 34 of each guide post 30. Of course, other arrangements of springs may be utilized to aid in the upward return of stripper-plate 35 without departing from the present invention. Once in this position, upper die shoe 25 is moved towards stripper-plate 35 and lower die shoe 26 such that guide posts 30 enter internal passageway 50 of each stripper guide bushing 40. It will be understood that internal anti-friction bearing assembly 42 provides smooth relative longitudinal movement between upper die shoe 25 and stripper guide bushing 40. At the same time, stripper-plate 35 is moved toward lower die shoe 26 so that each stripper guide bushing 40 enters a lower die guide bushing 31. Each return spring 46 is employed to automatically return die set 2 to an open position after each downward stroke of ram 11. Here again, external anti-friction bearing assembly 44 provides for smooth relative longitudinal movement between each stripper guide bushing 40 and each lower die guide bushing 31 thereby providing accurate guidance that allows for a non-fixed engagement between end 21 of ram 11 and upper die shoe 25.

In operation, the increased rigidity of alignment provided by stripper-plate alignment system 5 disassociates die set 2 from the over-powering alignment system of press ram 11. In other words, the combination of internal anti-friction bearing assembly 42, external anti-friction bearing assembly 44, stripper-plate guide bushings 40 and lower die shoe guide bushings 31 provide an essentially independent guidance system for die set 2 that is not coupled to the guides controlling the reciprocating movement of ram 11. In this way, internal and external anti-friction bearing assemblies 42,44 in combination with stripper-plate guide bushings 40 and lower die shoe guide bushings 31 alleviate effects from press ram misalignment. As a result of this improved arrangement, upper die shoe 25 does not require clamping or bolting to press ram 11, such that bulbous protrusion 24 is freely received within complementary recess 22, i.e., the bulbous protrusion is not fastened to upper die shoe 25, during operation of the system. This arrangement dramatically simplifies and reduces the time required to assemble die set 2 within press 8. In addition, die set 2 may be segmented into upper die shoe and stripper sections with each segment having its own stripper-plate. This enables critical stations in die set 2 to operate independently, so that scrap metal produced through the stamping operation does not effect other die stations (FIGS. 9-12). Either a single lower die shoe 26a may be used (FIG. 12) or a pair of lower die shoes 26 may be mounted upon a locator plate 60 (FIG. 9).

It is to be understood that the present invention is by no means limited only to the particular constructions herein disclosed and shown in the drawings, but also comprises any modifications or equivalents within the scope of the claims.

1. A metal stamping system comprising:
a press including a ram having a bulbous protrusion projecting outwardly from an end;
an upper die shoe including (i) a recess formed in a top surface, said recess being complementary to said bulbous protrusion, and (ii) a plurality of guide posts arranged in a pattern and projecting outwardly from a bottom surface, wherein said bulbous protrusion is received within said complementary recess;
a lower die shoe positioned in confronting relation to said surface and including a first plurality of open ended tubular guide bushings each having a first anti-friction bearing assembly positioned within a central passageway, and each located so as to receive a corresponding one of said guide posts; and
a stripper-plate positioned between said upper die shoe and said lower die shoe, including a second plurality of open-ended tubular guide bushings each having an outer surface and an inner surface and each projecting outwardly toward said lower die shoe in a pattern corresponding to said pattern of guide posts such that each of said first anti-friction bearing assemblies slidingly engages an outer surface of a corresponding one of said second open ended guide bushing, wherein each of said second plurality of open-ended guide bushings includes a second anti-friction bearing assembly positioned on said inner surface so as to engage a corresponding one of said guide posts; and
spring means for separating said upper shoe from said lower shoe after each downward stroke of said ram.

2-8. (canceled)

9. A metal stamping system according to claim 1 comprising a pair of upper die shoes, a pair of lower die shoes, and a pair of stripper-plates positioned between said upper die shoes and said lower die shoes, wherein said pair of lower die shoes is mounted upon an intermediate plate positioned upon a bolster.

10-21. (canceled)

22. A die set comprising:
two upper die shoes positioned adjacent to one another, and each including a plurality of guide posts arranged in a pattern and projecting outwardly from a surface;
two lower die shoes positioned adjacent to one another, and each positioned in confronting relation to a respective one of said surfaces, and each including a first plurality of open ended tubular guide bushings each having a first anti-friction bearing assembly positioned within a central passageway, and each located so as to receive a corresponding one of said guide posts; and
two stripper-plates, one positioned between each pair of said upper die shoes and said lower die shoes, and each including a second plurality of open-ended tubular guide bushings each having an outer surface and an inner surface and each projecting outwardly toward said lower die shoe in a pattern corresponding to said pattern of guide posts such that each of said first anti-friction bearing assemblies slidingly engages an outer surface of a corresponding one of said second open ended guide bushing, wherein each of said second plurality of open-ended guide bushings includes a second anti-friction bearing assembly positioned on said inner surface so as to engage a corresponding one of said guide posts.

23. A die set comprising:
two upper die shoes positioned adjacent to one another, each including a recess formed in a top surface, said recess being complementary to and receiving a bulbous protrusion located on a intermediary plate attached to a ram portion of a press, and each including a plurality of guide posts arranged in a pattern and projecting outwardly from a surface;
two lower die shoes positioned adjacent to one another, and each positioned in confronting relation to a respective one of said surfaces, and each including a first plurality of open ended tubular guide bushings each having a first anti-friction bearing assembly positioned within a central passageway, and each located so as to receive a corresponding one of said guide posts; and
two stripper-plates, one positioned between each pair of said upper die shoes and said lower die shoes, and each including a second plurality of open-ended tubular guide bushings each having an outer surface and an inner surface and each projecting outwardly toward said lower die shoe in a pattern corresponding to said pattern of guide posts such that each of said first anti-friction bearing assemblies slidingly engages an outer surface of a corresponding one of said second open ended guide bushing, wherein each of said second plurality of open-ended guide bushings includes a second anti-friction bearing assembly positioned on said inner surface so as to engage a corresponding one of said guide posts.
